(19) United States
(12) Patent Application Publication
(10) Pub. No.: US 2012/0285022 A1
(43) Pub. Date: Nov. 15, 2012

(54) RECIPROCATION DRIVING DEVICE FOR A HAIR CLIPPER BLADE ASSEMBLY

(76) Inventor: Huo-Pia Wang, Chang-Hua City (TW)

(21) Appl. No.: 13/104,357

(22) Filed: May 10, 2011

(51) Int. Cl. B26B 15/00

(52) U.S. Cl. 30/277.4

(57) ABSTRACT

A reciprocation driving device is adapted to be mounted in a housing of a hair clipper for reciprocating a moving blade of a blade assembly, and includes a stator unit and a rotor unit. The stator unit has a tubular shaft to permit a spindle of the rotor unit to be rotatably mounted therein by virtue of a pair of bearings, a bracing member disposed to be engaged with the housing, and a coil winding assembly disposed on the tubular shaft. The rotor unit has a carrier member extending radially and outwardly from a spindle end of the spindle to carry a permanently magnetic member so as to generate a torque as a result of electromagnetic forces acting between the rotor and stator units.

### BACKGROUND OF THE INVENTION

1. Field of the Invention

This invention relates to an electric hair clipper, more particularly to a reciprocation driving device for a hair clipper blade assembly.

2. Description of the Related Art

Referring to FIG. 1, a conventional electric motor 100 for a hair clipper is shown to include a motor mount 10 securely disposed in a housing 90 of the hair clipper, an annular magnet 11 disposed within the motor mount 10, and a rotor 12 surrounded by the annular magnet 11 and having a rotary spindle 122 supported by two anti-friction bearings. The rotary spindle 122 has an output shaft portion 121 extending outwardly of the motor mount 10 to be coupled to an eccentric cam 91, through which a rotation of the output shaft portion 121 is translated into a linear reciprocation of a moving blade 92 of a bladeset relative to a stationary blade 93 for cutting hair of humans or animals. However, since extension of an arm portion of the rotor 12 from the rotary spindle 122 is limited by the structure of the annular magnet 11 and the motor mount 10, only a relatively small torque can be generated for rotating the output shaft portion 121. Moreover, as the rotor 12 is rotatably mounted within and encircled by the motor mount 10, heat generated as a result of rotation of the rotor 12 cannot be dissipated therefrom, which may shorten the service life of the motor 100. Furthermore, a coil winding assembly 123 of the rotor 12 is bulky and needs a relatively large space and a large amount of winding materials, thereby resulting in high manufacturing costs.

### SUMMARY OF THE INVENTION

An object of the present invention is to provide a reciprocation driving device for a hair clipper blade assembly which has a high torque output shaft, which can achieve highly efficient heat dissipation, and which can be manufactured at relatively low costs.

According to this invention, the reciprocation driving device includes a stator unit, a rotor unit, and a pair of anti-friction bearings. The stator unit includes a tubular shaft, a bracing member, and a coil winding assembly. The tubular shaft has an axial hole extending along a shaft axis to terminate at first and second bearing surface regions. The bracing member has a web segment extending radially and outwardly from the tubular shaft adjacent to the first bearing surface region to terminate at a web marginal region, and a rim portion which extends from the web marginal region, and which is configured to be in fitting engagement with a housing of a hair clipper. The coil winding assembly is disposed on the tubular shaft. The rotor unit includes a spindle, a carrier member, and a permanently magnetic member. The spindle is adapted to couple to a moving blade of a blade assembly of the hair clipper to transmit a torque to reciprocate the moving blade. The spindle has first and second spindle ends opposite to each other, and is led to pass through the axial hole along the shaft axis to permit the first and second spindle ends to rotate relative to the tubular shaft, and outwardly of the first and second bearing surface regions, respectively. The carrier member has an arm extending radially and outwardly from the second spindle end to terminate at an arm end, and a carrier wall extending lengthwise from the arm end toward the rim portion. The permanently magnetic member is disposed on the carrier wall to radially confront the coil winding assembly such that the torque is generated by the spindle as a result of electromagnetic forces acting between the rotor and stator units. Each of the anti-friction bearings is disposed between the spindle and a respective one of the first and second bearing surface regions.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of a conventional hair clipper;

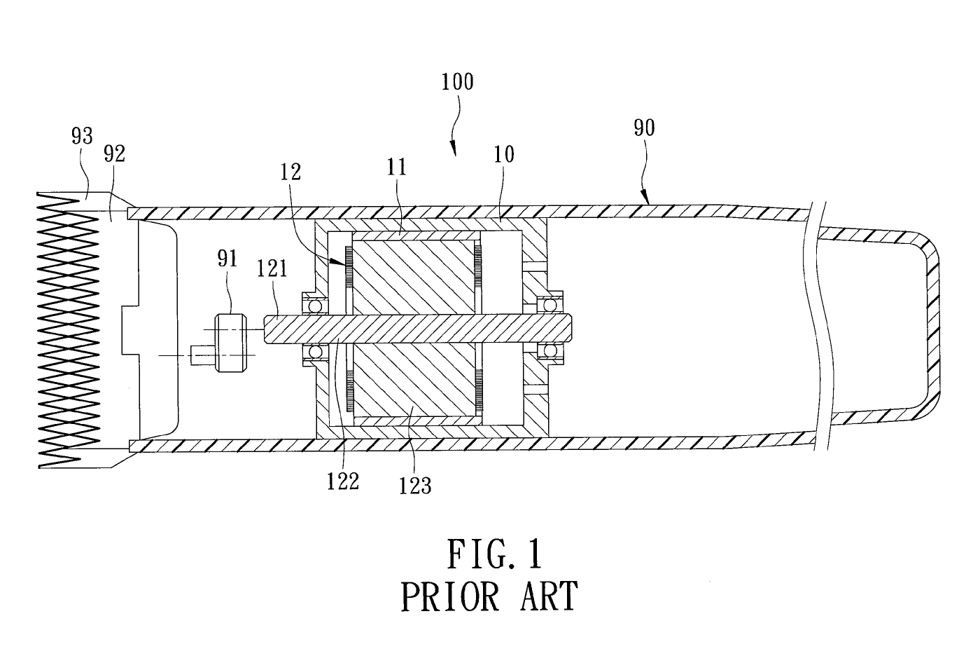

FIG. 2 is a sectional view of the first preferred embodiment of a reciprocation driving device according to this invention when incorporated with a hair clipper; and

FIG. 3 is a sectional view of the second preferred embodiment of a reciprocation driving device according to this invention when incorporated with a hair clipper.

### DETAILED DESCRIPTION OF THE PREFERRED EMBODIMENTS

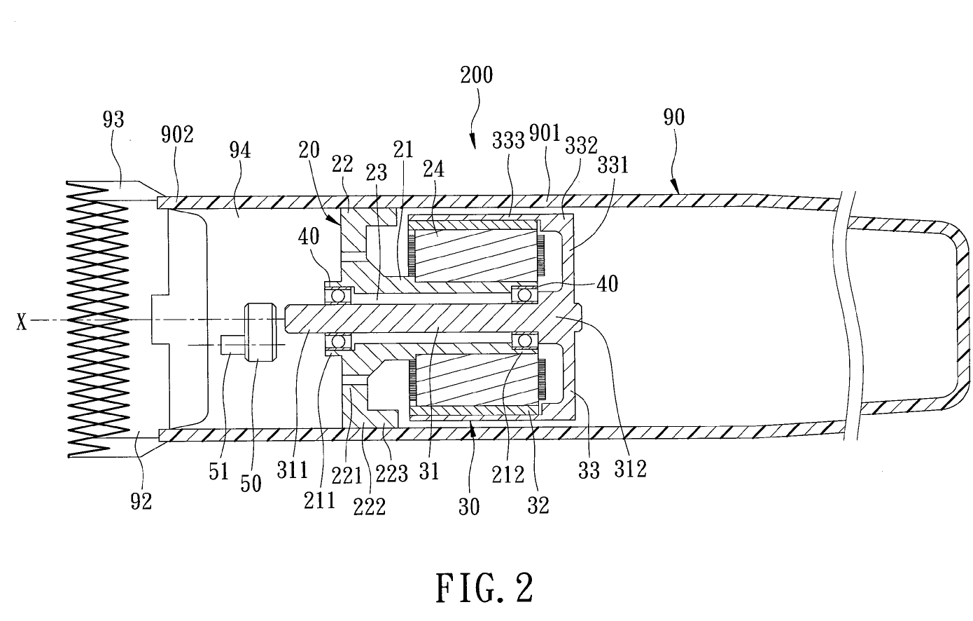

Referring to FIG. 2, the first preferred embodiment of a reciprocation driving device 200 for a hair clipper blade assembly according to the present invention is adapted to reciprocate a moving blade 92 relative to a stationary blade 93 of the blade assembly so as to effect a clipping action. The hair clipper includes a housing 90 which has a tubular body 901 extending along a lengthwise axis to terminate at a front end 902, and to define a tubular chamber 94 to permit the blade assembly to be disposed therein and to extend outwardly of the front end 902. The reciprocation driving device 200 of this embodiment is shown to comprise a stator unit 20, a rotor unit 30, a pair of anti-friction bearings 40, and an eccentric cam 50.

The stator unit 20 includes a tubular shaft 21 which has an axial hole 23 that extends along a shaft axis (X) to terminate at first and second bearing surface regions 211, 212, a bracing member 22 having a web segment 221 which extends radially and outwardly from the tubular shaft 21 adjacent to the first bearing surface region 211 to terminate at a web marginal region 222, and a rim portion 223 which extends from the web marginal region 222, and which is configured to be in fitting engagement with the tubular body 901 of the housing 90 so as to render the shaft axis (X) oriented along the lengthwise axis, and a coil winding assembly 24 which is disposed on the tubular shaft 21. The coil winding assembly 24 includes a plurality of windings that are disposed to be angularly displaced from one another about the shaft axis (X). The tubular shaft 21 may be integrally formed with the bracing member 22 into a single-piece structure,

The rotor unit 30 includes a spindle 31 which has first and second spindle ends 311, 312 opposite to each other along the lengthwise axis, and which is led to pass through the axial hole 23 along the shaft axis (X) to permit the first and second spindle ends 311, 312 to rotate relative to the tubular shaft 21, and outwardly of the first and second bearing surface regions 211, 212, respectively, a carrier member 33 which has an arm 331 that extends radially and outwardly from the second spindle end 312 to terminate at an arm end 332, and a carrier wall 333 that extends lengthwise from the arm end 332 toward the rim portion 223, and a permanently magnetic member 32 which is disposed on the carrier wall 333 to radially confront the coil winding assembly 24 and which has a permanently magnetic elements that are angularly displaced from one another about the shaft axis (X) such that a torque is generated by the spindle 31 as a result of electromagnetic forces acting between the rotor and stator units 20, 30. The spindle 31 may be integrally formed with the carrier member 33 into a single-piece structure.

Each of the anti-friction bearings 40 is disposed between the spindle 31 and a respective one of the first and second bearing surface regions 211, 212 so as to facilitate rotation of the spindle 31 about the shaft axis (X).

The eccentric cam 50 includes an eccentric stud 51 which extends lengthwise, and which is adapted to couple the spindle 31 to the moving blade 92 so as to transmit the torque to reciprocate the moving blade 92. In this embodiment, the first spindle end 311 of the spindle 31 is disposed adjacent to the eccentric cam 50 to serve as a coupled end that is configured to couple the spindle 31 to the eccentric cam 50.

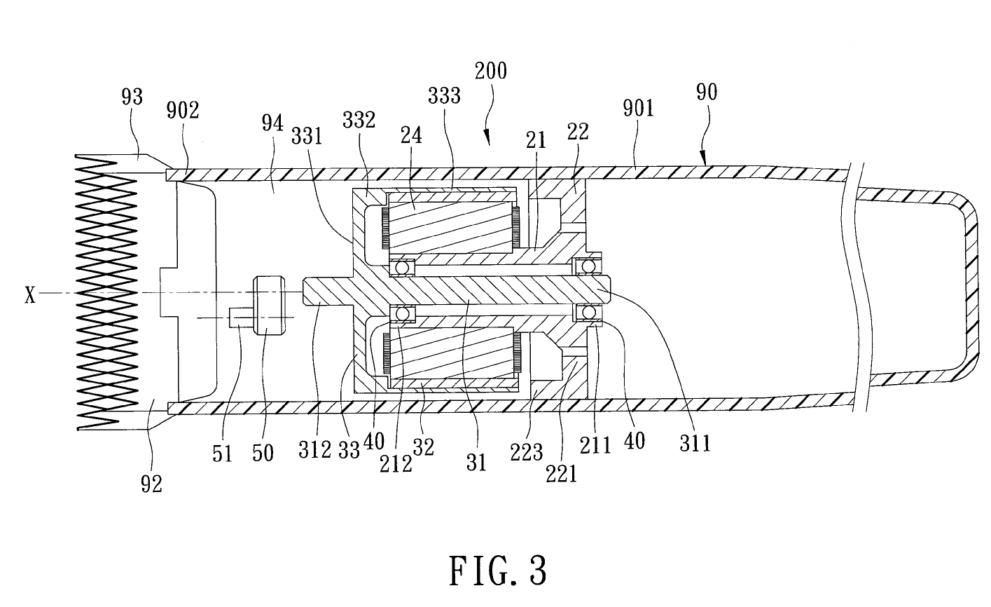

Referring to FIG. 3, in the second preferred embodiment of a reciprocation driving device 200 according to this invention, the second spindle end 312 is disposed adjacent to the eccentric cam 50 to serve as a coupled end that is configured to couple the spindle 31 to the eccentric cam 50.

As illustrated, since the coil winding assembly 24 and the bracing member 22 are disposed to be spaced apart from each other in the direction of the shaft axis (X), the permanently magnetic member 32 is disposed not to be confined by the bracing member 22, thereby enabling prolongation of the arm 331 of the carrier member 33 so as to generate a relatively great torque. Moreover, since the coil winding assembly 24 is not encircled by the bracing member 22, the heat generated therefrom can be dissipated effectively. Furthermore, the coil winding assembly 24 can be made more compact at relatively small manufacturing costs.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A reciprocation driving device for a blade assembly of a hair clipper which includes a housing which has a tubular body extending along a lengthwise axis to terminate at a front end, and to define a tubular chamber to permit the blade assembly to be disposed therein and to extend outwardly of the front end, the blade assembly including a stationary blade and a moving blade that is reciprocatingly movable relative to the stationary blade so as to effect a clipping action, the reciprocation driving device comprising:
a stator unit including
a tubular shaft which has an axial hole that extends along a shaft axis to terminate at first and second bearing surface regions,
a bracing member having a web segment which extends radially and outwardly from said tubular shaft adjacent to said first bearing surface region to terminate at a web marginal region, and a rim portion which extends from said web marginal region, and which is configured to be in fitting engagement with the tubular body of the housing so as to render the shaft axis oriented along the lengthwise axis, and
a coil winding assembly which is disposed on said tubular shaft;
a rotor unit including
a spindle adapted to couple to the moving blade to transmit a torque to reciprocate the moving blade, said spindle having first and second spindle ends opposite to each other along the lengthwise axis, and being led to pass through said axial hole along the shaft axis to permit said first and second spindle ends to rotate relative to said tubular shaft, and outwardly of said first and second bearing surface regions, respectively,
a carrier member which has an arm that extends radially and outwardly from said second spindle end to terminate at an arm end, and a carrier wall that extends lengthwise from said arm end toward said rim portion, and
a permanently magnetic member which is disposed on said carrier wall to radially confront said coil winding assembly such that the torque is generated by said spindle as a result of electromagnetic forces acting between said rotor and stator units; and
a pair of anti-friction bearings, each of which is disposed between said spindle and a respective one of said first and second bearing surface regions.

2. The reciprocation driving device according to claim 1, further comprising an eccentric cam which includes an eccentric stud that extends lengthwise, and that is adapted to couple said spindle to the moving blade so as to reciprocate the moving blade.

3. The reciprocation driving device according to claim 2, wherein said first spindle end is disposed adjacent to said eccentric cam to serve as a coupled end that is configured to couple said spindle to said eccentric cam.

4. The reciprocation driving device according to claim 2, wherein said second spindle end is disposed adjacent to said eccentric cam to serve as a coupled end that is configured to couple said spindle to said eccentric cam.

5. The reciprocation driving device according to claim 1, wherein said coil winding assembly includes a plurality of windings that are disposed to be angularly displaced from one another about the shaft axis, said permanently magnetic member includes a permanently magnetic elements that are angularly displaced from one another about the shaft axis.

6. The reciprocation driving device according to claim 1, wherein said tubular shaft is integrally formed with said bracing member into a single-piece structure, and said spindle is integrally formed with said carrier member into a single-piece structure.
